(19) United States
(12) Patent Application Publication
(10) Pub. No.: US 2010/0042775 A1
(43) Pub. Date: Feb. 18, 2010

(54) BLOCK MANAGEMENT METHOD FOR FLASH MEMORY, AND STORAGE SYSTEM AND CONTROLLER USING THE SAME

(75) Inventor: Chih-Kang Yeh, Kinmen County (TW)

Correspondence Address: J C PATENTS, 4 VENTURE, SUITE 250, IRVINE, CA, 92618, US

(73) Assignee: PHISON ELECTRONICS CORP., Miaoli (TW)

(21) Appl. No.: 12/274,001

(22) Filed: Nov. 19, 2008

(30) Foreign Application Priority Data
Aug. 12, 2008 (TW) 97130694

(51) Int. Cl. G06F 12/00

(52) U.S. Cl. 711/103; 711/118

(57) ABSTRACT

A block management method for managing a flash memory is provided. The method includes dividing the flash memory into a cache area and a storage area and dividing the cache area into a plurality of cache sub-areas, wherein the storage area has a plurality of physical blocks and each cache sub-area contains at least one physical block. The method also includes configuring a plurality of logical blocks for mapping the physical blocks of the storage area, and allocating one of the cache sub-areas for each logical block, wherein when the host writes the data into the logical blocks, the data may be temporarily stored in the cache sub-areas allocated for the logical blocks. Accordingly, it is possible to increase efficiency of the flash storage system and avoid wearing of the physical blocks, so as to prolong a lifetime of the flash storage system.

### CROSS-REFERENCE TO RELATED APPLICATION

This application claims the priority benefit of Taiwan application serial no. 97130694, filed on Aug. 12, 2008. The entirety of the above-mentioned patent application is hereby incorporated by reference herein and made a part of specification.

### BACKGROUND

1. Technology Field

The present invention relates to a block management method for a flash memory. More particularly, the present invention relates to a block management method taking a portion of a flash memory as a cache area, and a storage system and a controller using the same.

2. Description of Related Art

With a quick developing of digital cameras, cell phone cameras and MP3, demand of storage media by customers is increased greatly. Since a flash memory has the advantages of non-volatile, energy saving, small size and none mechanical structure etc., it is suitable for portable applications, and especially for portable battery-powered products. For example, a solid state disk (SSD) is a storage device applying a NAND flash memory as a storage medium.

Generally, the flash memory of a flash storage system is divided into a plurality of physical blocks, and the physical blocks are grouped into a data area and a spare area. The physical blocks grouped within the data area are used for storing valid data written based on write commands, and the physical blocks of the spare area are used for substituting the physical blocks in the data area while executing the write command. To be specific, when the flash storage system receives the write command from a host for writing data into the physical block of the data area, the flash storage system selects a physical block from the spare area, and writes old valid data stored in the physical block of the data area to be written and new data into the physical block selected from the spare area, and further associates the physical block written with the new data to the data area. Moreover, the original physical block in the data area is erased and is associated to the spare area. To smoothly access the physical blocks storing data in an alternation approach, the flash storage system can provide logical blocks to the host. Namely, the flash storage system can establish a logical-physical address mapping table, and record and update a mapping relation between the logical blocks and the physical blocks of the data area for reflecting alternations of the physical blocks, so that the host is only required to perform writing to the provided logical blocks, and the flash storage system then can read data from or write data into the mapped physical blocks according to the logical-physical address mapping table.

However, with progress of a fabrication process of the flash memory, while a volume design of each physical block becomes greater, time spent on moving the aforementioned old valid data is comparatively increased, so that a system performance is decreased. Particularly, when the flash storage system is used as a main storage medium for a computer operating system, the operating system may frequently access specific data (for example, a file allocation table (FAT)), and frequent accessing of the data of such kind of small files can prolong the time spent on moving the aforementioned old valid data, and accelerate wearing of the physical blocks. Therefore, improvement of data accessing efficiency of such kind of data and reducing wearing of the physical blocks of the flash memory are quite important.

### SUMMARY

Accordingly, the present invention is directed to a block management method, which can improve a data writing efficiency, so as to prolong a lifetime of a flash storage system.

The present invention is directed to a controller, which uses the aforementioned block management method for managing a flash memory, by which a data writing efficiency can be improved, so as to prolong a lifetime of a flash storage system.

The present invention is directed to a storage system, which uses the aforementioned block management method for managing a flash memory, by which a data writing efficiency can be improved, so as to prolong a lifetime of a flash storage system.

The principle aspect of the present invention provides a block management method for managing a flash memory of a flash storage system. The block management method includes dividing the flash memory into a cache area and a storage area and dividing the cache area into a plurality of cache sub-areas, wherein the storage area has a plurality of physical blocks and each cache sub-area contains at least one physical block. The block management method also includes configuring a plurality of logical blocks, wherein the logical blocks are mapped to the physical blocks of the storage area. The block management method also includes setting a configuration relation for the logical blocks and the divided cache sub-areas, wherein each of the logical blocks corresponds to one of the cache sub-areas, and when a host writes data into the logical blocks, the data is temporarily stored in the corresponded cache sub-areas.

The additional aspect of the present invention also provides a storage system and a controller thereof. The storage system includes a flash memory, a connector and a controller, wherein the flash memory has a plurality of physical blocks and the physical blocks are at least grouped into a data area and a spare area. The controller is electrically connected to the flash memory and the connector, and includes a micro-processing unit and a flash memory interface module, a buffer memory, a host interface module and a memory management module coupled to the micro-processing unit. Particularly, the memory management module has a plurality of machine commands, which when executed by the micro-processing unit, to perform the aforementioned block management steps for the flash memory.

In order to make the aforementioned and other objects, features and advantages of the present invention comprehensible, a preferred exemplary embodiment accompanied with figures is described in detail below.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain the principles of the invention.

FIG. 1 is a schematic block diagram illustrating a flash storage system according to an exemplary embodiment of the present invention.

FIG. 2A and FIG. 2B are schematic diagrams illustrating a storage area of FIG. 1 according to an exemplary embodiment of the present invention.

FIG. 2C is a schematic diagram illustrating a cache area of FIG. 1 according to an exemplary embodiment of the present invention.

FIG. 3 is a flowchart illustrating block management steps according to an exemplary embodiment of the present invention.

FIG. 4 is an example of a logical-physical address mapping table according to an exemplary embodiment of the present invention.

FIG. 5 is an example of a data address table according to an exemplary embodiment of the present invention.

FIG. 6 is a flowchart illustrating block management steps according to another exemplary embodiment of the present invention.

### DESCRIPTION OF EXEMPLARY EMBODIMENTS

To improve data accessing efficiency of a flash storage system, in the present invention, an area is plotted out from a flash memory of the flash storage system to serve as a cache area (or referred to as a buffer area), and such cache area is divided into a plurality of cache sub-areas. Meanwhile, logical blocks provided for being accessed by a host are respectively allocated to each one of the cache sub-areas, wherein when the host writes data into the flash storage system, the data is temporarily stored into a specific cache sub-area corresponding to the logical block to be written, and then the host is notified that write command thereof is completed. Next, during a non-busy time of the flash storage system, data in the cache sub-area is moved to a physical block ought to be written. Therefore, the data writing efficiency can be effectively improved, and wearing of the physical blocks can be reduced. Reference will now be made in detail to the present preferred exemplary embodiments of the invention, examples of which are illustrated in the accompanying drawings. Wherever possible, the same reference numbers are used in the drawings and the description to refer to the same or like parts.

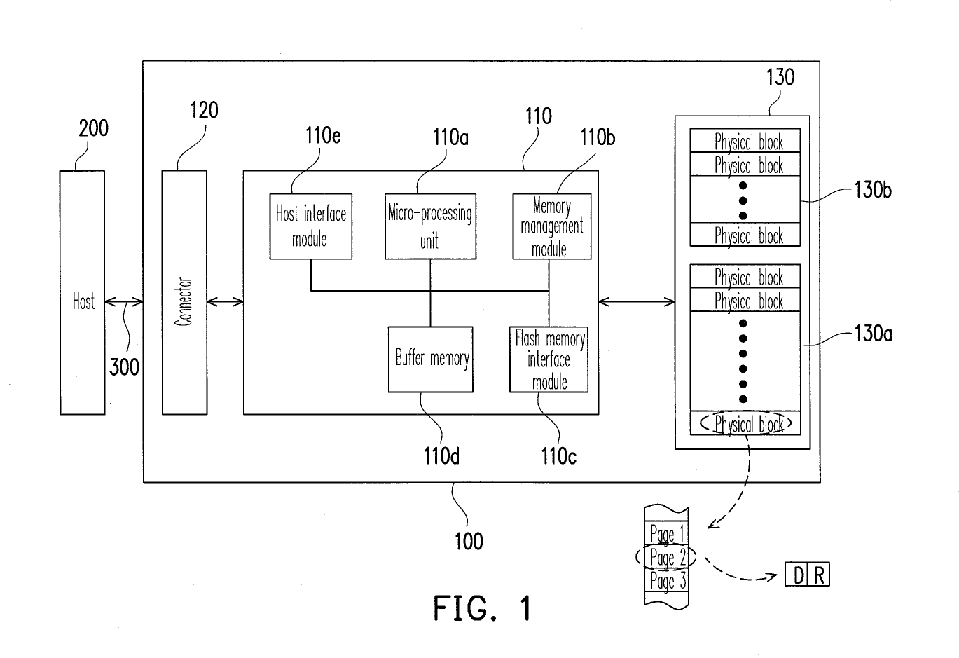

FIG. 1 is a schematic block diagram illustrating a flash storage system according to an exemplary embodiment of the present invention. Referring to FIG. 1, the flash storage system 100 includes a controller (which is also referred to as a controller system) 110, a connector 120 and a flash memory 130. Generally, the flash storage system 100 is utilized together with a host 200, so that the host 200 can write data into the flash storage system 100 or read data from the flash storage system 100. In the present exemplary embodiment, the flash storage system 100 is a solid state drive (SSD). It should be understood that, the flash storage system 100 can also be a memory card or a flash drive in another exemplary embodiment.

The controller 110 can execute a plurality of commands implemented by hardware, firmware or software to perform operations of data storing, data reading and data erasing, etc. in coordination with the connector 120 and the flash memory 130. The controller 110 includes a micro-processing unit 110a, a memory management module 110b, a flash memory interface module 110c, a buffer memory 110d and a host interface module 110e.

The micro-processing unit 110a is utilized together with the memory management module 110b, the flash memory interface module 110c, the buffer memory 110d and the host interface module 110e to perform various operations to the flash storage system 100.

The memory management module 110b is coupled to the micro-processing unit 110a, and has a plurality of machine commands that can be executed by the micro-processing unit 110a for managing the flash memory 130, for example, the machine commands for performing a wear levelling procedure, managing blocks and maintaining a logical-physical address mapping table, etc. Particularly, in the present exemplary embodiment, the memory management module 110b contains machine commands used for implementing block management steps of the present exemplary embodiment.

In the present exemplary embodiment, the memory management module 110b is implemented in the controller 110 in a firmware form, for example, the memory management module 110b is implemented by coding related machine commands by using a program language, and storing coded machine commands into a program memory (for example, a read only memory (ROM)). During operation of the flash memory storage system 100, the machine commands of the memory management module 110b is indirectly loaded into the buffer memory 110d for being executed by the micro-processing unit 110a or is directly executed by the micro-processing unit 110a to implement the aforementioned functions of performing the wear levelling procedure, managing damaged blocks, maintaining a logical-physical address mapping table, etc. Particularly, the controller 110 can execute the machine commands of the memory management module 110b to implement the block management steps of the present exemplary embodiment.

In another exemplary embodiment of the present invention, the machine commands of the memory management module 110b can also be stored in a specific area (for example, a system area in the flash memory that is specially used for storing system data) of the flash memory 130 in the firmware form. Similarly, during operation of the flash storage system 100, the plurality of machine commands of the memory management module 110b is loaded to the buffer memory 110d for being executed by the micro-processing unit 110a. Moreover, in another exemplary embodiment, the memory management module 110b can also be implemented in the controller 110 in a hardware form.

The flash memory interface module 110c is coupled to the micro-processing unit 110a for accessing the flash memory 130. Namely, data to be written into the flash memory 130 is first converted into a format that can be accepted by the flash memory 130 via the flash memory interface module 110c.

The buffer memory 110d is coupled to the micro-processing unit 110a for temporarily storing system data (for example, the logical-physical address mapping table) or data read or written by the host 200. In the present exemplary embodiment, the buffer memory 110d is a static random access memory (SRAM). However, it should be understood that the present invention is not limited thereof, and a dynamic random access memory (DRAM), a magnetoresistive random access memory (MRAM), a phase change random access memory (PRAM) or other suitable memories can also be applied.

The host interface module 110e is coupled to the micro-processing unit 110a and is used for receiving and identifying commands sent from the host 200. Namely, the commands and data sent from the host 200 are transmitted to the micro-processing unit 110a via the host interface module 110e. In the present exemplary embodiment, the host interface module 110e is a SATA interface. However, it should be understood that the present invention is not limited thereof, and the host interface module 110e can also be a USB interface, an IEEE 1394 interface, a PCI express interface, a MS interface, a MMC interface, a SD interface, a CF interface, an IDE interface or other suitable data transmission interfaces. Particularly, the host interface module 110e corresponds to the connector 120. Namely, the host interface module 110e has to be matched to the connector 120.

Moreover, though not illustrated, the controller 110 may further include general function modules such as an error correction module and a power management module, etc. for controlling the flash memory.

The connector 120 is used for connecting the host system 200 via a bus 300. In the present exemplary embodiment, the connector 120 is a SATA connector. However, it should be understood that the present invention is not limited thereto, and the connector 120 can also be a USB connector, an IEEE 1394 connector, a PCI express connector, a MS connector, a MMC connector, a SD connector, a CF connector, an IDE connector or other suitable connectors.

The flash memory 130 is electrically connected to the controller 110 for storing data. In the present exemplary embodiment, the flash memory 130 is a multi level cell (MLC) NAND flash memory. However, the present invention is not limited thereto, and in another exemplary embodiment, a single level cell (SLC) NAND flash memory can also be applied. The flash memory 130 is substantially divided into a plurality of physical blocks. Generally, the physical block is a minimum unit that can be erased within the flash memory. Namely, each of the physical blocks contains a minimum number of memory cells that can be erased together. Each of the physical blocks is generally divided into a plurality of pages, and the page is the minimum unit that can be programmed. It should be noted that according to different designs of the flash memory, the minimum programmable unit can also be a sector, namely, the page can be divided into a plurality of the sectors, and the sector is the minimum unit that can be programmed. In other words, the page is the minimum unit that data can be written on or read from. Each page generally includes a user data area D and a redundant area R. The user data area is used for storing a user data, and the redundant area is used for storing a system data (for example, an error correcting code (ECC)).

The data area D usually has 512 bytes and the redundant area R usually has 16 bytes in order to correspond to the size of a sector in a disk driver. Namely, one page is one sector. However, the page may also include a plurality of the sectors, for example, one page may include 4 sectors.

Generally, the physical block may include arbitrary number of pages, for example, 64 pages, 128 pages, 256 pages etc. The physical blocks are generally grouped into a plurality of zones, and managing of the memory based on the zones results in the fact that the zones can be operated independently, so as to increase a parallel degree of operation, and simplify a complexity of the management.

In the present exemplary embodiment, the flash memory 130 is divided into a storage area 130a and a cache area 130b, wherein the storage area 130a is used for storing data, and the cache area 130b is used for temporarily storing data. To be specific, when the host 200 write data into the flash storage system 100, the controller 110 temporarily stores the data into the cache area 130b first for accelerating processing of the write command, and then writes the data into the storage area 130a.

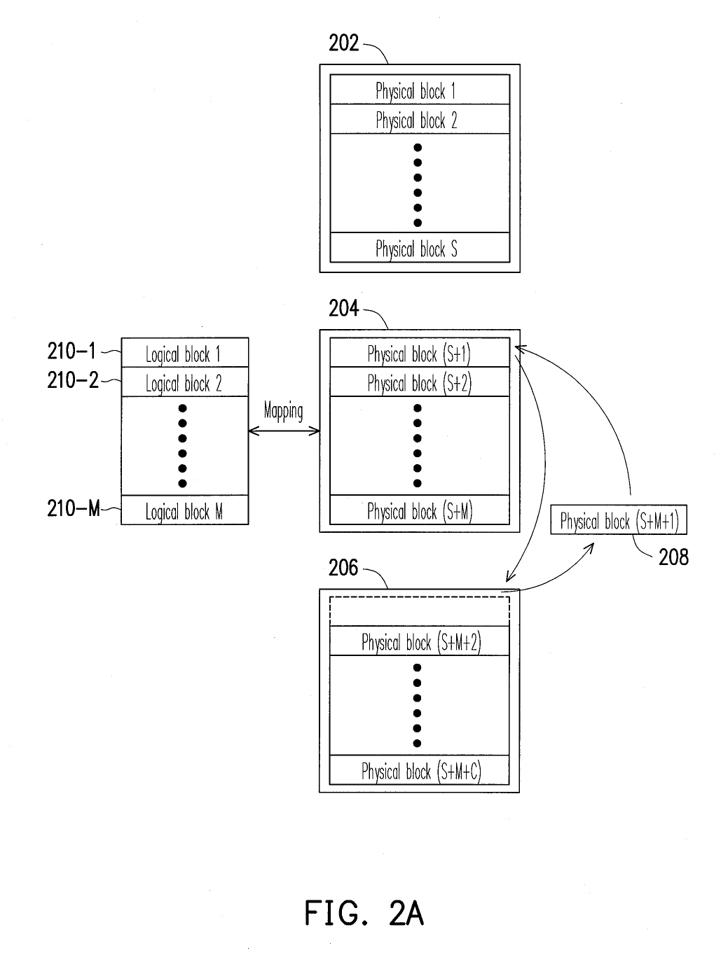

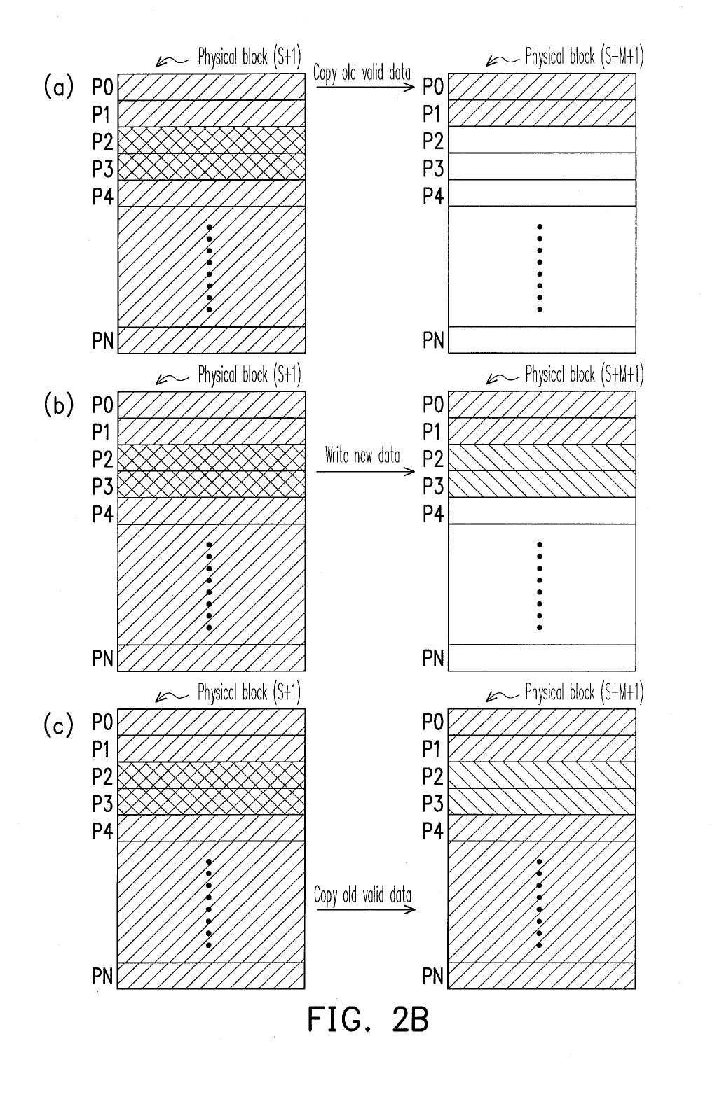

FIG. 2A and FIG. 2B are schematic diagrams illustrating the storage area 130a of FIG. 1 according to an exemplary embodiment of the present invention.

It should be noted that when operations of the flash memory are described, the terms used such as “select”, “move”, “exchange”, “substitute”, “alternate”, “divide” and “group”, etc. for operating the physical blocks of the flash memory are only logical concepts. Namely, actual positions of the physical blocks are not changed, and the physical blocks of the flash memory are only operated logically. It should be noted that in the following content, operations of the physical blocks are implemented by executing the machine commands of the memory management module 110b by the controller 110.

Referring to FIG. 2A, in the present exemplary embodiment, to effectively program (i.e. write and erase) the flash memory 130, the controller 110 logically groups the physical blocks of the storage area 130a into a system area 202 (i.e. a physical block 1˜a physical block S), a data area 204 (i.e. a physical block (S+1)˜a physical block (S+M)) and a spare area 206 (i.e. a physical block (S+M+1)˜a physical block (S+M+C)). As described above, the physical blocks of the flash memory 130 are alternately provided to the host for storing data, so that the controller 110 can provide logical blocks 210-1˜210-M to the host for data accessing, and record the physical blocks mapped to the logical blocks by maintaining the logical-physical address mapping table. In the present exemplary embodiment, S, M and C are positive integers respectively representing an amount of the physical blocks of each of the areas, which can be set according to a capacity of the utilized flash memory by a flash storage system manufacturer.

The physical blocks of the system area 202 are used for recording system data, and the system data is for example, the number of zones of the flash memory 130, physical block numbers of each area, page numbers of each physical block, and the logical-physical address mapping table recording mapping relations of the logical blocks and the physical blocks, etc.

The physical blocks of the data area 204 are used for storing user data, which are generally the physical blocks mapped to the logical blocks accessed by the host 200.

The physical blocks of the spare area 206 are used for substituting the physical blocks in the data area 204. Therefore, the physical blocks of the spare area 206 can be empty or applicable physical blocks, i.e. blocks that are not stored with data or blocks stored with data marked to be invalid.

Particularly, the physical blocks of the data area 204 and the spare area 206 are alternately used for storing data that the host 200 writes into the flash storage system 100. To be specific, since each address in the flash memory can only be programmed once, if data is about to be written to the locations with data thereon, erasing of the existing data has to be performed first. However, as mentioned above, the page is the minimum writable unit, and the physical block is the minimum erasable unit. The minimum writable unit is less than the minimum erasable unit. Therefore, if the physical block is about to be erased, data of the valid pages within the physical block to be erased have to be copied to the other physical blocks first.

For example, when the host is about to write data to the logical blocks 210-1 (i.e. the logical block 1), the controller 110 obtains information that the logical block 1 is presently mapped to the physical block (S+1) in the data area 204 via the logical-physical address mapping table. Therefore, the flash memory storage system 100 may update the data stored in the physical block (S+1). Meanwhile, the controller 110 selects a physical block (S+M+1) from the spare are 206 to substitute the physical block (S+1) of the data area 204. However, while the new data is written into the physical block (S+M+1), all of the valid data stored in the physical block (S+1) may not be immediately moved to the physical block (S+M+1) for erasing the physical block (S+1). To be specific, the controller 110 copies the old valid data of the pages (i.e. pages P0 and P1) in the physical block (S+1) to be written to the physical block (S+M+1) (shown as (a) of FIG. 2B), and writes the new data (i.e. pages P2 and P3 of the physical block (S+M+1)) to the physical block (S+M+1) (shown as (b) of FIG. 2B). Now, the physical block (S+M+1) containing a part of the old valid data and the written new data is temporarily associated to a substitute physical block 208. This is because the valid data on the physical block (S+1) may become invalid during a next operation (for example, a write command). Therefore, immediate movement of all of the valid data on the physical block (S+1) to the physical block (S+M+1) is unnecessary. In this case, integration of the data on the physical block (S+1) and the substitute physical block (S+M+1) is the data on the mapped logical block 1. A number of such mother-child blocks (i.e. the physical block (S+1) and the substitute physical block (S+M+1)) can be determined by the size of the buffer memory 110d within the controller 110, and five groups are taken as an example in the present exemplary embodiment. Operation for temporarily maintaining such transient relation between such mother-child blocks is referred to as opening of the mother-child blocks.

Next, when the data of the physical block (S+1) and the data of the substitute physical block (S+M+1) need to be actually integrated, the controller 110 combines the physical block (S+1) and the physical block (S+M+1) to be one block, so as to improve a utilization efficiency of the blocks, and such a combination operation is referred to as closing of the mother-child blocks. For example, as shown in (c) of FIG. 2B, when the mother-child blocks are closed, the controller 110 copies the remained valid data (i.e. pages P4-PN) in the physical block (S+1) to the substitute physical block (S+M+1), and erases the physical block (S+1) and associates it to the spare area 206. Meanwhile, the physical block (S+M+1) is associated to the data area 204, and the logical block 1 in the logical-physical address mapping table is changed to map to the physical block (S+M+1), so as to complete operation of closing the mother-child blocks.

As the capacity of the flash memory gradually increases, time spent on opening the mother-child blocks and moving the old valid data is increased accordingly, so that the controller 110 may spend longer time to complete the write command. Therefore, in the present exemplary embodiment, the controller 110 allocates a portion of the physical blocks of the flash memory 130 to be the cache area 130b.

The physical blocks of the cache area 130b are used for temporarily storing data written by the host 200. Namely, when the host 200 sends the write command to the flash storage system 100, the controller 110 temporarily stores the data to be written into the cache area 130b, and responses the host 200 that the write command is completed. Next, during a non-busy time of the flash storage system 100, the controller 110 moves the data stored in the cache area 130b to the data area 204. Namely, the controller 110 executes the aforementioned time-consuming operation of opening the mother-child blocks (shown as FIG. 2B) during the non-busy time of the flash storage system 100 for writing the data temporarily stored in the cache area 130b into the physical blocks ought to be written.

FIG. 2C is a schematic diagram illustrating the cache area 130b of FIG. 1 according to an exemplary embodiment of the present invention.

Referring to FIG. 2C, in the present exemplary embodiment, the controller 110 divides the cache area 130b into a plurality of cache sub-areas 220-1˜220-N, and the 220-1˜220-N are respectively allocated to the logical blocks 210-1˜210-M (wherein N and M are positive integers). Namely, each of the logical blocks corresponds to a specific cache sub-area. Generally, the number of the cache sub-areas is less than that of the logical blocks, and therefore multi logical blocks may share one cache sub-area.

Next, when the controller 110 temporarily stores the data written by the host 200 into the cache area 130b, the controller 110 temporarily stores the data into the allocated specific cache sub-area corresponding to the logical block to be written. For example, in the present exemplary embodiment, the controller 110 allocates a cache sub-area 220-P to a logical block 210-K, wherein K and P are integers, and P is a remainder of K divided by N shown as a following equation (1):

P=K(mod N)1≦K≦M (1)

Namely, in the present exemplary embodiment, if N=4, data to be written to the logical blocks 210-1, 210-5 and 210-9, . . . is temporarily stored into the cache sub-area 220-1, data to be written to the logical blocks 210-2, 210-6, and 210-10, . . . is temporarily stored into the cache sub-area 220-2, data to be written to the logical blocks 210-3, 210-7, and 210-11, . . . is temporarily stored into the cache sub-area 220-3, and data to be written to the logical blocks 210-4, 210-8, and 210-12, . . . is temporarily stored into the cache sub-area 220-4.

In the present exemplary embodiment, the logical blocks non-consecutively correspond to the cache sub-areas. However, in another exemplary embodiment of the present invention, the logical blocks can consecutively correspond to the cache sub-areas. For example, in the aforementioned exemplary embodiment, the logical blocks 210-1, 210-2, 210-3, . . . , 210-S can correspond to the cache sub-area 220-1, the logical blocks 210-(S+1), 210-(S+2), 210-(S+3), . . . , 210-2S can correspond to the cache sub-area 220-2, the logical blocks 210-(2S+1), 210-(2S+2), 210-(2S+3), . . . , 210-3S can correspond to the cache sub-area 220-3, and the logical blocks 210-(3S+1), 210-(3S+2), 210-(3S+3), . . . can correspond to the cache sub-area 220-4.

Moreover, in the present exemplary embodiment, configuration relation for the logical blocks and the cache sub-areas are preset by a static approach. However, in another exemplary embodiment of the present invention, when the controller temporarily stores the data into the cache sub-areas, the allocated cache sub-areas can also be set by a dynamic approach. For example, when the controller temporarily stores the data into the cache sub-areas, the controller can judge whether a specific cache sub-area is allocated to the logical block to be written, and if the specific cache sub-area is not allocated to the logical block to be written, the controller 110 selects a cache sub-area that is least utilized by the logical blocks from the cache sub-areas to serve as the corresponding specific cache sub-area.

As described above, in the present exemplary embodiment, the controller 110 allocates the cache sub-areas corresponding to the logical blocks. Namely, the controller 110 writes data into different cache sub-areas based on the logical blocks to be written. However, in another exemplary embodiment of the present invention, the controller 110 can also allocate the cache sub-areas corresponding to the physical blocks of the storage area 130a. Namely, the controller 110 writes data into different cache sub-areas based on the physical blocks of the storage area 130a to be written, wherein in case of such an allocation approach, configuration relation for the physical blocks and the cache sub-areas can be set according to the equation (1).

In the present exemplary embodiment, one physical block corresponds to one cache sub-area. However the present invention is not limited thereto, and in another exemplary embodiment of the present invention, a plurality of the physical blocks can correspond to one cache sub-area.

In the following content, the block management method of the flash storage system 100 is described in detail with reference of figures.

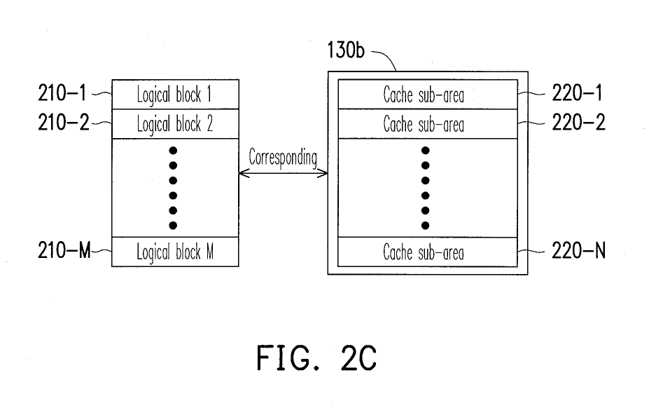

FIG. 3 is a flowchart illustrating block management steps according to an exemplary embodiment of the present invention. Wherein, these steps are implemented by executing the machine commands of the memory management module 110b via the micro-processing unit 110a of the controller 110. It should be noted that execution sequence of the block management steps is not limited to that shown in FIG. 3, and those skilled in the art can arbitrarily arrange the block management steps according to the spirit of the present invention.

Referring to FIG. 3, in step S301, the controller 110 divides the flash memory 130 into the storage area 130a and the cache area 130b. Next, in step S303, the controller 110 divides the cache area 130b into a plurality of the cache sub-areas 220-1˜220-N. Dividing method of the cache area 130b has been described above, and therefore detailed description thereof is not repeated.

In step S305, the controller 110 configures the logical blocks 210-1˜210-M for being accessed by the host 200, and in step S307, a configuration relation for the logical blocks 210-1˜210-M and the divided cache sub-areas 220-1˜220-N is set.

Next, in step S309, the write command and data are received from the host 200. It should be noted that in the flowchart, only the specific steps in allusion to the write command are executed by the flash storage system 100, so that in the step S309, the follow-up steps are executed only when the write command is received. However, the flash storage system 100 can also execute other commands (for example, a read command).

In step S311, the controller 110 confirms the allocated cache sub-areas corresponding to the logical blocks to be written. Next, in step S313, the controller 110 temporarily stores the data into the allocated cache sub-areas.

Next, in step S315, the controller 110 judges whether any of the cache sub-areas within the cache area 130b is fully stored with data. If it is judged in the step S315 that there is a sub-area is fully stored with data, in step S317, the controller 110 arranges such cache sub-area fully stored with data. Namely, the controller 110 writes the data of such cache sub-area into the storage area, and erases the cache sub-area for further utilization when the controller 110 continually executes the write command.

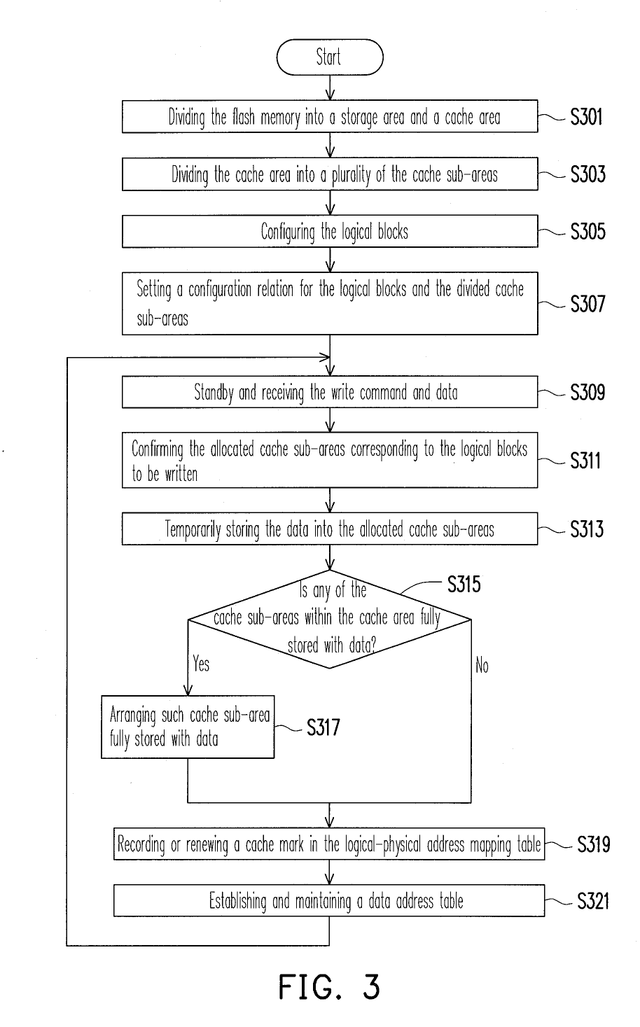

Next, in step S319, the controller 110 records or renews a cache mark in the logical-physical address mapping table for representing whether the data is temporarily stored in the cache sub-area. To be specific, the controller 110 adds a one-bit data in the logical-physical address mapping table for representing whether the data is temporarily stored in the cache sub-area. For example, the logical-physical address mapping table 400 includes a logical block filed 402, a physical block field 404 and a cache mark field 406, wherein the logical block field 402 and the physical block field 404 are used for recording the logical blocks and the physical blocks mapping the logical blocks, and if a value of the cache mark field 406 is “1”, it represents a part of data of the logical block is stored in the cache area 130b, and if the value of the cache mark field 406 is “0”, it represents none data of the logical block is stored in the cache area 130b. For example, as shown in FIG. 4, the logical block 1 maps to the physical block (S+1) and a part of data of the logical block 1 is stored in the cache area 130b.

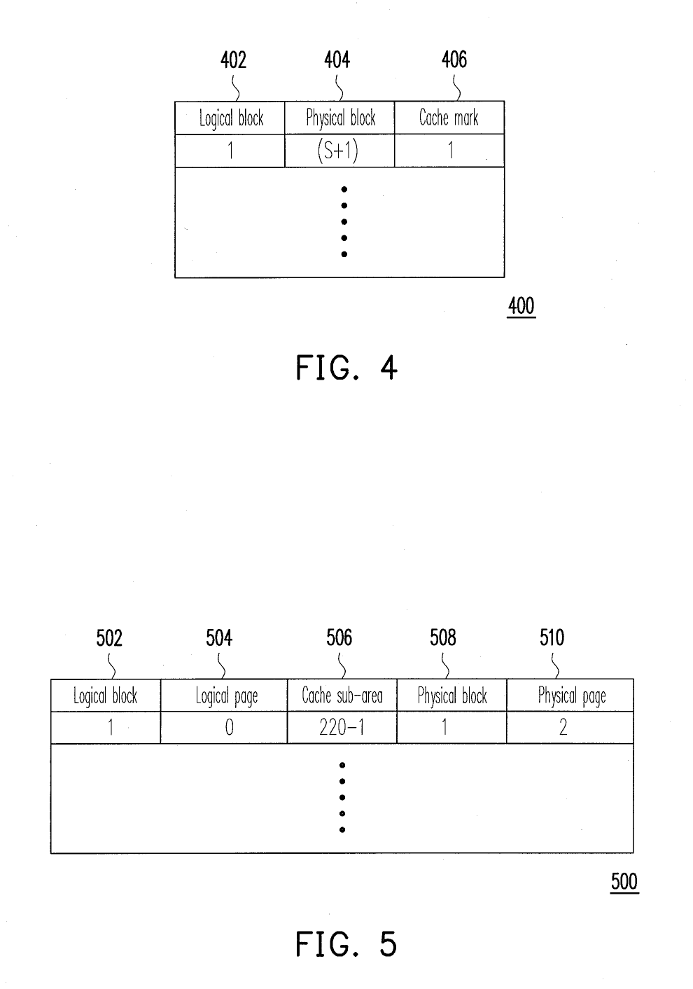

Meanwhile, in step S321, the controller 110 establishes and maintains a data address table 500 for the logical block having data stored in the cache area 130b, wherein the data address table 500 is used for recording which cache sub-area is currently used for storing data of each page of each of the logical blocks. For example, in an exemplary embodiment of the present invention, the data address table 500 of FIG. 5 includes a logical block field 502, a logical page field 504, a cache sub-area field 506, a physical block field 508 and a physical page field 510. For example, the controller 110 can obtain information that data of page 0 of the logical block 1 is recorded in page 2 of the physical block 1 in the cache sub-area 220-1 according to such record (shown as the example of FIG. 5). Next, when the controller 110 executes a read command, the data can be correctly read according to information recorded based on the steps S319 and S321. It should be noted that the controller 110 can quickly read data stored in the address to be read according the data address table recorded based on the steps S319 and S321. However, in another exemplary embodiment of the present invention, the controller 110 can also directly find a correct data recording address according to information of the redundant area R of the page without recording the data address table.

After the step S321, the step S309 is repeated for waiting a next write command. Though not illustrated in FIG. 3, those skilled in the art can easily know that the block management steps of FIG. 3 are ended when a shut down or a power-off command is received.

It should be noted that in another exemplary embodiment of the present invention, the controller 110 stores a division result of the cache area and the configuration relation for the logical blocks and the cache sub-areas into the flash memory 130 (for example, a system area 202) before the flash storage system 100 is turned off. Therefore, when the flash storage system 100 is rebooted, the controller 110 can directly read the stored data, and execution of the steps S301, S303 and S305 is unnecessary.

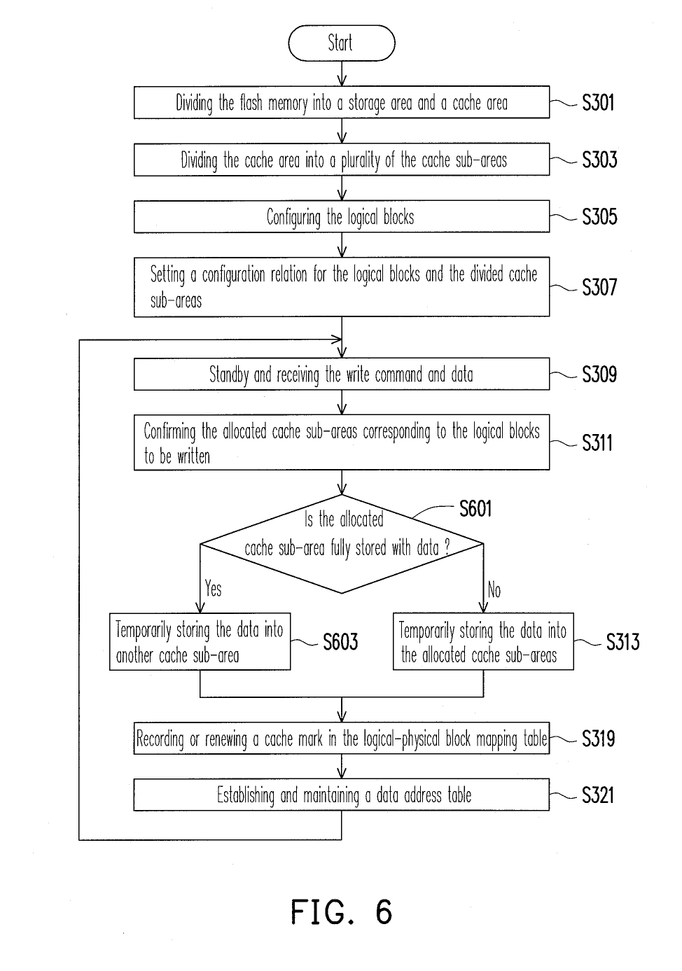

Moreover, in another exemplary embodiment of the present invention, the steps S315 and S317 can also be omitted. To be specific, the controller 110 does not immediately perform an arranging operation to the corresponding cache sub-area when it is fully stored with data, but temporarily stores the data in other cache sub-areas, and later performs the arranging operation during the non-busy period of the flash storage system 100. As shown in FIG. 6, in step S601, the controller 110 judges whether the corresponding cache sub-area is fully stored with data. If in the step S601, it is judged that the cache sub-area is not fully stored with data, step S313 is executed, and if in the step S601, it is judged that the cache sub-area is fully stored with data, in step S603, the controller 110 temporarily stores the data into another cache sub-area.

It should be noted that the flash memory 130 of the present exemplary embodiment is a MLC NAND flash memory, and programming of the physical blocks of the MLC NAND flash memory includes multi stages. For example, taking a 4-level cell as an example, programming of the physical blocks includes two stages. In a first stage, the lower pages are programmed, and a physical characteristic thereof is similar to that of the SLC NAND flash memory. After the first stage is completed, the upper pages are programmed, wherein data writing speed of the lower page is faster than that of the upper page. Therefore, the pages of each physical block can be divided into slow pages (i.e. the upper pages) and fast pages (i.e. the lower pages). Similarly, in case of an 8-level cell and a 16-level cell, the memory cell may include more pages, and can be programmed in more stages. Here, the page having a fastest writing speed is referred to as the lower page, and other pages having relatively slow writing speeds are all referred to as the upper pages. For example, the upper pages include a plurality of the pages having different writing speeds. Moreover, in other exemplary embodiments, the upper page can also be a page having a lowest writing speed, or the page having the lowest writing speed and the pages having writing speeds thereof being faster than the lowest writing speed. For example, in the 4-level cell, the lower pages are pages having the fastest writing speed and sub-fastest writing speeds, and the upper pages are pages having the lowest writing speed and sub-lowest writing speeds. Therefore, in another exemplary embodiment of the present invention, since the writing speed of the lower pages is faster than that of the upper pages, in the step S311, the controller 110 can store the data only to the lower pages of the physical block of the cache sub-area, so as to accelerate the writing speed of the cache area 130b.

In summary, in the present invention, the cache area is divided into a plurality of the cache sub-areas, and the logical blocks respectively correspond to the cache sub-areas, so that when data is temporarily stored into the cache area, the data can be stored into a specific cache sub-area according to different logical blocks. Accordingly, when the flash storage system needs to arrange the cache area, the arrangement can be performed based on a unit of the cache sub-area, so as to reduce time spent on moving the data. Moreover, since data of the same cache sub-area belongs to the specific logical block, so that wearing of the physical blocks caused by arranging excessive logical blocks due to excessive scattering of the data in different physical blocks can be avoided.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A block management method for a flash memory of a flash storage system, the block management method comprising:
dividing the flash memory into a cache area and a storage area, wherein the storage area has a plurality of physical blocks;
dividing the cache area into a plurality of cache sub-areas, wherein each of the cache sub-areas contains at least one physical block;
configuring a plurality of logical blocks, wherein the logical blocks are mapped to the physical blocks of the storage area; and
setting a configuration relation for the logical blocks and the cache sub-areas, wherein each of the logical blocks corresponds to one of the cache sub-areas,
wherein when a host writes data into one of the logical blocks, the data is temporarily stored in the cache sub-area corresponding to the one of the logical blocks.

2. The block management method as claimed in claim 1, further comprising when at least one of the cache sub-areas is fully stored with data, writing the data temporarily stored in the at least one cache sub-area into the storage area.

3. The block management method as claimed in claim 1, further comprising when the cache sub-area corresponding to the one of the logical blocks have no space to store the data, temporarily storing the data in the other cache sub-areas.

4. The block management method as claimed in claim 1, wherein the step of setting the configuration relation for the logical blocks and the cache sub-areas comprises allocating the cache sub-areas corresponding to the logical blocks based on a current usage rate of the cache sub-areas when the host writes data into the logical blocks.

5. The block management method as claimed in claim 1, further comprising
recording a cache mark in a logical-physical address mapping table to represent data of the logical blocks is temporarily stored in the cache sub-areas; and
establishing a data address table to record physical pages in the cache sub-areas storing the data.

6. The block management method as claimed in claim 1, wherein the step of dividing the cache area into the cache sub-areas comprises dividing the cache area into N cache sub-areas, and the step of configuring the logical blocks to be accessed by the host comprises configuring M logical blocks, wherein N and M are positive integers, and
the step of setting the configuration relation for the logical blocks and the cache sub-areas comprises corresponding a K-th logical block to a P-th cache sub-area, wherein K is a positive integer less than (M+1), and P equals to a remainder of K divided by N.

7. The block management method as claimed in claim 1, wherein the flash memory is a multi level cell (MLC) NAND flash memory and the physical blocks of the cache sub-areas have a plurality of upper pages and a plurality of lower pages having a writing speed faster than that of the upper pages, and
the step of temporarily storing the data into the cache sub-areas corresponding to the one of the logical blocks comprises temporarily storing the data only to the lower pages of the cache sub-areas.

8. A controller, adapted to manage a flash memory of a flash storage system, the controller comprising:
a micro-processing unit;
a flash memory interface, coupled to the micro-processing unit;
a buffer memory, coupled to the micro-processing unit; and
a memory management module, coupled to the micro-processing unit, and having a plurality of machine commands that can be executed by the micro-processing unit to perform a plurality of block management steps for the flash memory, and the block management steps comprising:
dividing the flash memory into a cache area and a storage area, wherein the storage area has a plurality of physical blocks;
dividing the cache area into a plurality of cache sub-areas, wherein each of the cache sub-areas contains at least one physical block;
configuring a plurality of logical blocks, wherein the logical blocks are mapped to the physical blocks of the storage area; and
setting a configuration relation for the logical blocks and the cache sub-areas, wherein each of the logical blocks corresponds to one of the cache sub-areas,
wherein when a host writes data into one of the logical blocks, the data is temporarily stored in the cache sub-areas corresponding to the one of the logical blocks.

9. The controller as claimed in claim 8, wherein the block management steps further comprise when at least one of the cache sub-areas is fully stored with data, writing the data temporarily stored in the at least one cache sub-area into the storage area.

10. The controller as claimed in claim 8, wherein the block management steps further comprise when the cache sub-area corresponding to the one of logical blocks have no space to store the data, temporarily storing the data in the other cache sub-areas.

11. The controller as claimed in claim 8, wherein the step of setting the configuration relation for the logical blocks and the cache sub-areas comprises allocating the cache sub-areas corresponding to the logical blocks based on a current usage rate of the cache sub-areas when the host writes data into the logical blocks.

12. The controller as claimed in claim 8, wherein the block management steps further comprise:
recording a cache mark in a logical-physical address mapping table to represent data of the logical blocks is temporarily stored in the cache sub-areas; and
establishing a data address table to record physical pages in the cache sub-areas storing the data.

13. The controller as claimed in claim 8, wherein the step of dividing the cache area into the cache sub-areas comprises dividing the cache area into N cache sub-areas, and the step of configuring the logical blocks to be accessed by the host comprises configuring M logical blocks, wherein N and M are positive integers, and
the step of setting the configuration relation for the logical blocks and the cache sub-areas comprises corresponding a K-th logical block to a P-th cache sub-area, wherein K is a positive integer less than (M+1), and P equals to a remainder of K divided by N.

14. The controller as claimed in claim 8, wherein the flash memory is a MLC NAND flash memory and the physical blocks of the flash memory have a plurality of upper pages and a plurality of lower pages having a writing speed faster than that of the upper pages, and
the step of temporarily storing the data into the cache sub-areas corresponding to the one of the logical blocks comprises temporarily storing the data only to the lower pages of the cache sub-areas.

15. A flash storage system, comprising:
a flash memory;
a connector; and
a controller, electrically connected to the flash memory and the connector, the controller executing a plurality of machine commands of a memory management module to perform a plurality of block management steps, and the block management steps comprising:
dividing the flash memory into a cache area and a storage area, wherein the storage area has a plurality of physical blocks;
dividing the cache area into a plurality of cache sub-areas, wherein each of the cache sub-areas contains at least one physical block;
configuring a plurality of logical blocks, wherein the logical blocks are mapped to the physical blocks of the storage area; and
setting a configuration relation for the logical blocks and the cache sub-areas, wherein each of the logical blocks corresponds to one of the cache sub-areas,
wherein when a host writes data into one of the logical blocks, the data is temporarily stored in the cache sub-areas corresponding to the one of the logical blocks.

16. The flash storage system as claimed in claim 15, wherein the block management steps further comprise when at least one of the cache sub-areas is fully stored with data, writing the data temporarily stored in the at least one cache sub-area into the storage area.

17. The flash storage system as claimed in claim 15, wherein the block management steps further comprise when the cache sub-area corresponding to the one of the logical blocks have no space to store the data, temporarily storing the data in the other cache sub-areas.

18. The flash storage system as claimed in claim 15, wherein the step of setting the configuration relation for the logical blocks and the cache sub-areas comprises allocating the cache sub-areas corresponding to the logical blocks based on a current usage rate of the cache sub-areas when the host writes data into the logical blocks.

19. The flash storage system as claimed in claim 15, wherein the block management steps further comprise:
recording a cache mark in a logical-physical address mapping table to represent data of the logical blocks is temporarily stored in the cache sub-areas; and
establishing a data address table to record physical pages in the cache sub-areas storing the data.

20. The flash storage system as claimed in claim 15, wherein the step of dividing the cache area into the cache sub-areas comprises dividing the cache area into N cache sub-areas, and the step of configuring the logical blocks to be accessed by the host comprises configuring M logical blocks, wherein N and M are positive integers, and
the step of setting the configuration relation for the logical blocks and the cache sub-areas comprises corresponding a K-th logical block to a P-th cache sub-area, wherein K is a positive integer less than (M+1), and P equals to a remainder of K divided by N.

21. The flash storage system as claimed in claim 15, wherein the flash memory is a MLC NAND flash memory and the physical blocks of the flash memory have a plurality of upper pages and a plurality of lower pages having a writing speed faster than that of the upper pages, and
the step of temporarily storing the data into the cache sub-areas corresponding to the one of the logical blocks comprises temporarily storing the data only to the lower pages of the cache sub-areas.

22. A block management method, for a flash memory of a flash storage system, the block management method comprising:
dividing the flash memory into a cache area and a storage area, wherein the storage area has a plurality of physical blocks;
dividing the cache area into a plurality of cache sub-areas, wherein each cache sub-area contains at least one physical block; and
setting a configuration relation for the physical blocks and the cache sub-areas, wherein each of the physical blocks corresponds to one of the cache sub-areas,
wherein when a host writes data into one of the physical blocks, the data is temporarily stored in the cache sub-area corresponding to the one of the physical blocks.
